(19) United States
(12) Patent Application Publication
(10) Pub. No.: US 2017/0251373 A1
(43) Pub. Date: Aug. 31, 2017

(54) METHOD FOR ENABLING COMMUNICATION ON UNLICENSED SPECTRUM AND CORRESPONDING BASE STATION AND USER EQUIPMENT

(71) Applicant: Sharp Kabushiki Kaisha, Sakai City, Osaka (JP)

(72) Inventors: Ming DING, Shanghai (CN); Qi JIANG, Shanghai (CN); Renmao LIU, Shanghai (CN)

(73) Assignee: Sharp Kabushiki Kaisha, Sakai City, Osaka (JP)

(21) Appl. No.: 15/505,986

(22) PCT Filed: Aug. 26, 2015
(86) PCT No.: PCT/CN2015/088125

§ 371 Date: Feb. 23, 2017

(30) Foreign Application Priority Data
Aug. 29, 2014 (CN) 201410437653.6

(51) Int. Cl. H04W 16/14; H04W 72/04; H04L 5/00

(52) U.S. Cl. CPC H04W 16/14; H04L 5/0048; H04W 72/042

(57) ABSTRACT

The present disclosure provides a method performed by a base station for enabling communication on an unlicensed spectrum and the base station. The method comprises: transmitting, by the base station, an Unlicensed-Discovery Reference Signal (U-DRS) on an unlicensed carrier. The base station can configure a UE with unlicensed carriers for the UE to monitor the U-DRS. The method can further comprise: transmitting, by the base station, a reference signal for measuring Channel State Information (CSI) on the unlicensed carrier. The base station can configure a UE with unlicensed carriers for the UE to measure CSI and receive downlink data. The method can further comprise: transmitting, by the base station, downlink data to the UE on the unlicensed carrier. The present disclosure further provides a method performed by a UE and the UE, corresponding to the above method and base station

### TECHNICAL FIELD

The present disclosure relates to wireless communications, and more particularly, to a method for enabling communication on unlicensed spectrum and a corresponding base station and a user equipment.

### BACKGROUND

Modern wireless mobile communication systems have two significant characteristics. The first one is broadband and high rate. For example, the fourth generation wireless mobile communication systems have up to 100 MHz of bandwidth and up to 1 Gbps of downlink rate. The second one is mobile interconnecting, which enables emerging services such as mobile internet, mobile video on demand, online navigation, and the like. These two characteristics have higher requirements on the wireless mobile communication technology, including ultrahigh rate wireless transmission, inter-area interference suppression, reliable signal transmission while moving, distributed/centered signal processing, etc. In the enhanced fourth generation (4G) and the fifth generation (5G) in the future, in order to meet the above development requirements, various key techniques have been proposed and discussed, and are worth extensive attention of researchers in the related field.

In October of 2007, the International Telecom Union (ITU) has approved the Worldwide Interoperability for Microwave Access (WiMAX) as the fourth 3G system standard. This event, which happened at the end of the 3G era, is in fact a rehearsal of the 4G standard war. Indeed, in order to confront the challenges from the wireless IP technology represented by wireless local area network (WLAN) and WiMAX, the 3GPP organization has set out to prepare for its new system upgrade—standardization of the Long Term Evolution (LTE) system. As a quasi-4G system which is based on Orthogonal Frequency Division Multiplexing (OFDM), the LTE system had its first release published in 2009, and was subsequently put into commercial use in 2010. Meanwhile, the standardization of the 4G wireless mobile communication system was also started by 3GPP in the first half of 2008, and this system were referred to as Long Term Evolution Advanced (LTE-A). The critical standard specification for physical layer procedures of that system was completed in early 2011. In November of 2011, the ITU officially announced in Chongqing, China that the LTE-A system and the WiMAX system are two official standards for 4G systems. Nowadays, global commercialization of the LTE-A system is progressing step by step.

According to the challenges of the next decade, the enhanced fourth generation wireless mobile communication systems have generally the following development requirements:
Higher wireless broadband rate and optimization of local cell hot spots;
Further improved user experience, especially optimization of communication services for cell border areas;
Continuous researches on new techniques capable of improving spectral utilization, due to impossibility of 1,000 times of expansion of available spectrums;
Use of high frequency spectrums (5 GHz or even higher) to obtain large communication bandwidth;
Cooperation with existing networks (2G/3G/4G, WLAN, WiMax, etc.) to share data traffic;
Specific optimization for different traffics, applications and services;
Enhanced system capabilities for enabling large scale Machine Type Communications;
Flexible, intelligent and inexpensive network planning and deployment; and
Designs for saving power consumptions of networks and UE batteries.

In the conventional 3GPP LTE system, data transmission can only occur on licensed spectrums, or licensed bands/carriers. However, with the rapid growth of traffic, it may be difficult for the licensed spectrums to satisfy the requirements of the increasing traffic, especially in some urban hot-spots. In the 3GPP RAN #62 meeting, a new research topic, i.e., a study on unlicensed (or unlicensed bands/carriers), has been discussed (RP-132085), referred to as LTE-Unlicensed (LTE-U). Its main purpose is to study non-standalone deployment of LTE on unlicensed spectrums. The term “non-standalone” means that communication on an unlicensed spectrum is associated with a serving cell on a licensed spectrum. A straightforward scheme is to reuse the Carrier Aggregation (CA) feature in the LTE system, i.e., to deploy a licensed spectrum as a Primary Component Carrier (PCC) of a serving base station and an unlicensed spectrum as a Secondary Component Carrier (SCC) of the serving base station.

However, when an unlicensed spectrum is used in the conventional LTE system, the following problems may rise:
There could be networks with other access technologies on the unlicensed spectrum e.g., Wi-Fi network coverage. A mechanism for interference avoidance needs to be introduced in the LET system, such that it can share the unlicensed spectrum with systems such as Wi-Fi in a dynamic and opportunistic manner. The dynamic sharing requires the LTE system to utilize the unlicensed spectrum quickly for communication. The opportunistic sharing requires the LTE system to detect an idle condition on the unlicensed spectrum, use the unlicensed spectrum, and then release it timely, without significantly disturbing the existing systems. However, the current LTE system cannot utilize spectral resources dynamically and opportunistically.
The bandwidth of the unlicensed spectrum (up to 500 MHz) may be much wider than the maximum bandwidth the LTE system supports (100 MHz). Thus, an enhanced cross carrier scheduling scheme and a corresponding configuration scheme need to be designed for UEs utilizing the unlicensed spectrum.
The communications on the unlicensed spectrum are mainly downlink communications. In the initial version of LTE-U, uplink communications may not be considered.

### SUMMARY

It is an object of the present disclosure to provide methods for enabling communication on an unlicensed spectrum and an associated base station and UE.

According to a first aspect of the present disclosure, a method performed by a base station for enabling communication on an unlicensed spectrum is provided. The method comprises: transmitting, by the base station, an Unlicensed-Discovery Reference Signal (U-DRS) on an unlicensed carrier. Optionally, the method can further comprise: transmitting, by the base station, a reference signal for measuring Channel State Information (CSI) on the unlicensed carrier.

Optionally, the method can further comprise: transmitting, by the base station, downlink data to a User Equipment (UE) on the unlicensed carrier.

Optionally, the method can further comprise: configuring, by the base station, a UE with unlicensed carriers for the UE to monitor the U-DRS.

Optionally, the method can further comprise: configuring, by the base station, a UE with unlicensed carriers for the UE to measure CSI and receive downlink data.

Optionally, a subset of the unlicensed carriers for the UE to monitor the U-DRS is selected as the unlicensed carriers for the UE to measure CSI and receive downlink data. Alternatively, all of the unlicensed carriers for the UE to monitor the U-DRS are selected as the unlicensed carriers for the UE to measure CSI and receive downlink data.

Optionally, the U-DRS contains at least a portion of CSI Reference Signal (CSI-RS) or a portion of Common Reference Signal (CRS).

Optionally, the U-DRS is transmitted at a lower power than a transmission power of downlink data or a reference signal on a licensed carrier.

Optionally, the method can further comprise: configuring, by the base station, the UE with a signal Energy Per Resource Element (EPRE) ratio, which is a ratio of an EPRE of the downlink data to an EPRE of the CSI-RS or CRS or a ratio of an EPRE of CSI-RS or CRS on the licensed carrier to an EPRE of the CSI-RS or CRS.

Optionally, the signal EPRE ratio can be configured via CC-specific and/or UE-specific Radio Resource Control (RRC) signaling.

Optionally, the method can further comprise: configuring, by the base station, the UE with a signal energy value which is an energy value of the CSI-RS or CRS.

Optionally, the signal energy value can be configured via CC-specific and/or UE-specific Radio Resource Control (RRC) signaling.

Optionally, the signal EPRE ratio has a value range of non-negative dB values.

Optionally, a short ID of each licensed or unlicensed carrier is indicated by an existing information element “SCellIndex” in LTE RRC signaling. A detailed configuration of each unlicensed carrier is indicated by an existing information element “SCellToAddMod-r10” in LTE RRC signaling modified by adding frequency information of the unlicensed carrier.

Optionally, a short ID of each unlicensed carrier is indicated by a newly defined information element “U-SCellIndex”, each “U-SCellIndex” being linked with a virtual “SCellIndex”. A detailed configuration of each unlicensed carrier comprises at least a short ID of the unlicensed carrier indicated by “U-SCellIndex”, a virtual “SCellIndex” and frequency information of the unlicensed carrier.

Optionally, the virtual “SCellIndex” has a value range of [N, 8], wherein N is an integer larger than 0 and smaller than 8.

Optionally, a short ID of each licensed or unlicensed carrier is indicated by an existing information element “SCellIndex” in LTE RRC signaling. A detailed configuration of each unlicensed carrier is indicated by an existing information element “SCellToAddMod-r10” in LTE RRC signaling modified by: adding a carrier type flag indicating whether a particular “SCellIndex” corresponds to a licensed carrier or an unlicensed carrier, and/or, when the carrier type flag indicates an unlicensed carrier, adding list information carrying configurations for a set of candidate unlicensed carriers.

Optionally, when the carrier type flag indicates a licensed carrier, the licensed carrier can be configured via an existing information element “SCellToAddMod-r10” in LTE RRC signaling.

Optionally, the configurations for a set of candidate unlicensed carriers may comprise at least a sub-index “U-SCellSubIndex” of a candidate unlicensed carrier and frequency information of the corresponding unlicensed carrier.

Optionally, an uplink configuration of the unlicensed carrier can be removed.

Optionally, the unlicensed carriers for the UE to measure CSI and receive downlink data can be indicated as using cross carrier scheduling.

Optionally, an existing information element “CrossCarrierSchedulingConfig” in LTE RRC signaling is used to indicate the unlicensed carriers for the UE to measure CSI and receive downlink data as using cross carrier scheduling.

Optionally, the unlicensed carriers for the UE to measure CSI and receive downlink data can be indicated as having no downlink control channel.

Optionally, the method further comprises: transmitting, by the base station, cross carrier scheduling information to the UE on a licensed carrier. The downlink data is transmitted on an unlicensed carrier indicated by the cross carrier scheduling information.

Optionally, the “SCellIndex” of the unlicensed carrier is carried by a CIF in DCI of the licensed carrier, thereby indicating that the unlicensed carrier is being cross carrier scheduled.

Optionally, a reserved state of the CIF in the DCI of the licensed carrier indicates the current downlink scheduling as cross carrier scheduling for the unlicensed carrier, and a number of bits in another field or a number of newly defined bits in the DCI are used for carrying “U-SCellIndex” information, thereby indicating which unlicensed carrier the current downlink scheduling is intended for.

Optionally, some “SCellIndex” have been defined as representing unlicensed carriers, a CIF in DCI of the licensed carrier is configured to be such “SCellIndex” to indicate the current downlink scheduling as cross carrier scheduling for an unlicensed carrier represented by the “SCellIndex”, and a number of bits in another field or a number of newly defined bits in the DCI are used for carrying “U-SCellIndex” information, thereby indicating which unlicensed carrier among the unlicensed carriers represented by the “SCellIndex” the current downlink scheduling is intended for.

Optionally, the number of bits in the other filed in the DCI comprises “HARQ process number” and/or “Downlink Assignment Index” in the DCI.

Optionally, no downlink control channel can be configured on the unlicensed carrier.

Optionally, the method can further comprise: receiving, by the base station, a monitor report on the unlicensed carrier, a CSI report and acknowledgement information indicating whether the downlink data has been successfully transmitted, as fed back from the UE

According to a second aspect of the present disclosure, a method performed by a User Equipment (UE) for enabling communication on an unlicensed spectrum is provided. The method comprises: receiving, by the UE, an Unlicensed-Discovery Reference Signal (U-DRS) transmitted from a base station on an unlicensed carrier.

Optionally, the method can further comprise: receiving, by the UE, a reference signal for measuring Channel State Information (CSI) transmitted from the base station on the unlicensed carrier.

Optionally, the method can further comprise: receiving, by the UE, downlink data transmitted from the base station on the unlicensed carrier.

Optionally, the method can further comprise: feeding back, by the UE, acknowledgement information indicating whether the downlink data has been successfully received.

Optionally, the method can further comprise: receiving, by the UE, a configuration of unlicensed carriers for monitoring the U-DRS from the base station on a licensed carrier.

Optionally, the method can further comprise: receiving, by the UE, a configuration of unlicensed carriers for measuring CSI and receiving downlink data from the base station on a licensed carrier.

Optionally, a subset of the unlicensed carriers for monitoring the U-DRS is selected as the unlicensed carriers for measuring CSI and receiving downlink data. Alternatively, all of the unlicensed carriers for monitoring the U-DRS are selected as the unlicensed carriers for measuring CSI and receiving downlink data.

Optionally, the method can further comprise: monitoring, by the UE, the U-DRS on the unlicensed carrier and feeding a monitor report back to the base station; and measuring, by the UE, CSI on the unlicensed carrier and feeding it back.

Optionally, the method can further comprise: receiving, by the UE, cross carrier scheduling information on a licensed carrier. The downlink data is received on an unlicensed carrier indicated by the cross carrier scheduling information.

According to a third aspect of the present disclosure, a base station is provided. The base station comprises: a transmission unit configured to transmit an Unlicensed-Discovery Reference Signal (U-DRS) on an unlicensed carrier.

Optionally, the transmission unit is further configured to transmit a reference signal for measuring Channel State Information (CSI) on the unlicensed carrier.

Optionally, the transmission unit is further configured to transmit downlink data to a User Equipment (UE) on the unlicensed carrier.

Optionally, the base station can further comprise: a configuration unit configured to generate a first unlicensed carrier configuration for configuring unlicensed carriers for the UE to monitor the U-DRS. The transmission unit is configured to transmit the first unlicensed carrier configuration on a licensed carrier.

Optionally, the base station can further comprise: a configuration unit configured to generate a second unlicensed carrier configuration for configuring unlicensed carriers for the UE to measure CSI and receive downlink data. The transmission unit is configured to transmit the second unlicensed carrier configuration on a licensed carrier.

Optionally, a subset of the unlicensed carriers for the UE to monitor the U-DRS is selected as the unlicensed carriers for the UE to measure CSI and receive downlink data. Alternatively, all of the unlicensed carriers for the UE to monitor the U-DRS are selected as the unlicensed carriers for the UE to measure CSI and receive downlink data.

Optionally, the base station can further comprise: a scheduling unit configured to generate cross carrier scheduling information. The transmission unit is further configured to transmit cross carrier scheduling information on a licensed carrier. The downlink data is transmitted on an unlicensed carrier indicated by the cross carrier scheduling information.

Optionally, the base station can further comprise: a reception unit configured to receive a monitor report on the unlicensed carrier, a CSI report and acknowledgement information indicating whether the downlink data has been successfully transmitted, as fed back from the UE.

According to a fourth aspect of the present disclosure, a User Equipment (UE) is provided. The UE comprises: a reception unit configured to receive an

Unlicensed-Discovery Reference Signal (U-DRS) on an unlicensed carrier.

Optionally, the reception unit is further configured to receive a reference signal for measuring Channel State Information (CSI) on the unlicensed carrier.

Optionally, the reception unit is further configured to receive downlink data on the unlicensed carrier.

Optionally, the reception unit is further configured to receive a configuration of unlicensed carriers for monitoring the U-DRS on a licensed carrier.

Optionally, the reception unit is further configured to receive a configuration of unlicensed carriers for measuring CSI and receiving downlink data from the base station on a licensed carrier.

Optionally, a subset of the unlicensed carriers for monitoring the U-DRS is selected as the unlicensed carriers for measuring CSI and receiving downlink data. Alternatively, all of the unlicensed carriers for monitoring the U-DRS are selected as the unlicensed carriers for measuring CSI and receiving downlink data.

Optionally, the UE can further comprise: a measurement unit configured to measure the U-DRS and generate a measurement report, and to measure CSI and generate a CSI report; and a transmission unit configured to transmit the measurement report based on the U-DRS and the CSI report.

Optionally, the reception unit is further configured to receive cross carrier scheduling information on a licensed carrier. The UE can further comprise: a data decoding unit configured to decode the cross carrier scheduling information. The downlink data is received on an unlicensed carrier indicated by the cross carrier scheduling information.

Optionally, the data decoding unit is further configured to decode the downlink data and generate acknowledgement information indicating whether the downlink data has been successfully received. The transmission unit is further configured to feed the acknowledgement information back to a base station.

### BRIEF DESCRIPTION OF THE DRAWINGS

The above and other features will be more apparent from the following description of embodiments with reference to the figures, in which:

FIG. 1 is a flowchart showing an embodiment of the present disclosure;

FIG. 2 is a block diagram of a base station according to an embodiment of the present disclosure; and

FIG. 3 is a block diagram of a UE according to an embodiment of the present disclosure.

### DETAILED DESCRIPTION

In the following, the methods for enabling communication on an unlicensed spectrum and the associated base station and UE according to the present disclosure will be described with reference to the drawings and embodiments.

It should be noted that, in the following, the solutions according to the present disclosure will be described for the purpose of illustration only. The present disclosure is not necessarily limited to the steps and unit structures described below. The steps and unit structures can be adjusted and/or omitted as appropriate. Hence, some of the steps and elements are not essential elements necessary for implementing the general inventive concept of the present disclosure. Thus, the essential technical features of the present disclosure are only subjected to the minimum requirements for implementing the general inventive concept of the present disclosure, rather than being limited to the following examples. Further, details of well-known techniques which are not directly relevant to the present disclosure will be omitted so as not to obscure the concept of the present disclosure.

In the following, a number of embodiments of the present invention will be detailed in an exemplary application environment of LTE mobile communication system and its subsequent evolutions. Herein, it is to be noted that the present invention is not limited to the application exemplified in the embodiments. Rather, it is applicable to other communication systems, such as the future 5G cellular communication system.

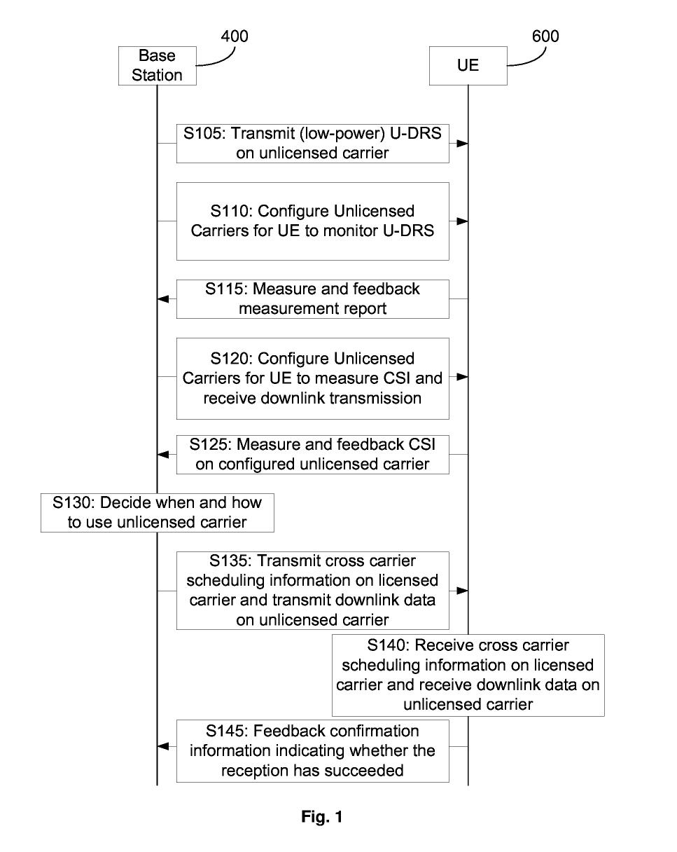

FIG. 1 is a schematic diagram showing possible operations at a base station and a UE for enabling communication on an unlicensed spectrum according to an embodiment of the present disclosure. As shown, the exemplary embodiment includes the following steps.

At step S105, the base station transmits an Unlicensed-Discovery Reference Signal (U-DRS) to the UE on an unlicensed carrier.

In this step, the U-DRS is always transmitted in the system, even when there are already other systems. Optionally, the U-DRS is a low power U-DRS. Here, “low power” means that the transmission of the U-DRS is lower than that of an ordinary downlink transmission signal, e.g., a data signal. The U-DRS is used for synchronization of LTE-U UE and/or Radio Resource Management (RRM) and/or obtainment of coarse (and fine) Channel State Information (CSI). The purpose of low power transmission of the U-DRS is to reduce interference with other systems (e.g., Wi-Fi).

It is to be noted here that the base station may detect a presence of a nearby Wi-Fi access point, e.g., by searching for beacon signals of the Wi-Fi access point.

For design of the U-DRS, it can contain at least (a portion of) CSI Reference Signal (CSI-RS) or (a portion of) Common Reference Signal (CRS) in LTE system. Accordingly, a signal Energy Per Resource Element (EPRE) ratio needs to be defined. Preferably, the signal EPRE ratio can be configured via CC-specific and/or UE-specific Radio Resource Control (RRC) signaling. Preferably, the signal EPRE ratio is a ratio of an EPRE of an LTE-U data signal (Physical Downlink Shared Channel, or PDSCH) to an EPRE of the CSI-RS or CRS. Preferably, the signal EPRE ratio is a ratio of an EPRE of CSI-RS or CRS on the licensed carrier to an EPRE of the CSI-RS or CRS on the unlicensed carrier. Preferably, the signal EPRE ratio has a value range of non-negative dB values. Alternatively, a signal energy value needs to be defined. Preferably, the signal energy value is an energy value of the CSI-RS or CRS. Preferably, the signal energy value can be configured via CC-specific and/or UE-specific Radio Resource Control (RRC) signaling.

It is to be noted here that the UE-specific signal EPRE ratio has a technical effect that the base station configured with LTE-U can apply different downlink power controls to different UEs.

Correspondingly to the step S105, the UE receives the U-DRS on the unlicensed carrier, so as to discover the base station on the unlicensed carrier. As such, the step S105 provides fundamental support to communication on the unlicensed spectrum.

At step S110, optionally, the base station configures a UE with unlicensed carriers for the UE to monitor the U-DRS.

In order to implement this step, the present disclosure provides three schemes based on RRC signaling, as follows.

Scheme 1: a short ID of each licensed or unlicensed carrier is indicated by an existing Information Element (IE) “SCellIndex” (see TS 36.331) in RRC signaling of the current LTE system.

Further, a detailed configuration of each unlicensed carrier is similar to an existing IE “SCellToAddMod-r10” in RRC signaling of the current LTE system, with a modification (non-limiting) to add frequency information (frequency point, bandwidth, etc.) of the unlicensed carrier and/or to remove an uplink configuration of the unlicensed carrier.

In addition, the U-DRSs on the unlicensed carriers need to be configured, including the CC-specific and/or UE-specific power information as described above in connection with the step S105.

It is to be noted here that Scheme 1 is advantageous in its simplicity. However, it has an obvious drawback, i.e., the LTE-U UE has limited opportunity to use the unlicensed carrier. This is mainly because the value of “SCellIndex” in the current LTE system ranges from 1 to 7 and these very limited values are shared by licensed and unlicensed carriers. Of course, this drawback can be overcome by expanding the value range of “SCellIndex” to e.g., a maximum value of 15.

As an embodiment, the configuration of one unlicensed carrier indicated by “SCellIndex” includes the frequency information (frequency point, bandwidth, etc.) of the unlicensed carrier, which is similar to the frequency band indication corresponding to dl-CarrierFreq in TS 36.331. The exact frequency point information corresponding to the frequency band indication can be obtained from e.g., E-UTRA Operating Band in Table 5.7.3-1 of TS 36.101. It is to be noted here that all the tables here similar to Table 5.7.3-1 are tables of new frequency bands available at 5 GHz as predefined for LTE-U, as shown in Table 1 for example.

TABLE 1
Examples of Unlicensed Operating Bands

| E-UTRA Unlicensed | Frequency Band |
|---|---|
| Operating Band | Range (MHz) |
| 1 | 5170-5190 |
| 2 | 5190-5210 |
| 3 | 5210-5230 |
| 4 | 5230-5250 |
| 5 | 5250-5270 |
| 6 | 5270-5290 |
| 7 | 5290-5310 |
| 8 | 5310-5330 |
| 9 | 5490-5510 |
| 10 | 5510-5530 |
| 11 | 5530-5550 |
| 12 | 5550-5570 |
| 13 | 5570-5590 |
| 14 | 5590-5610 |
| 15 | 5610-5630 |
| 16 | 5630-5650 |
| 17 | 5650-5670 |
| 18 | 5670-5690 |
| 19 | 5690-5710 |
| 20 | 5710-5730 |
| 21 | 5735-5755 |
| 22 | 5755-5775 |
| 23 | 5775-5795 |
| 24 | 5795-5815 |
| 25 | 5815-5835 |

For configuration of the U-DRS, as an embodiment, a configuration of the CSI-RS can be used as a portion of the configuration of the U-DRS. In the configuration of the CSI-RS, a CC-specific and/or UE-specific RRC parameter (denoted as e.g., P_{C} or P_{D}) is defined as a ratio of an EPRE of LTE-U PDSCH to an EPRE of the CSI-RS or a ratio of an EPRE of CSI-RS or CRS on the licensed carrier to an EPRE of the CSI-RS. Further, if a low power U-DRS is adopted, the signal EPRE ratio has a value range of non-negative dB values. Alternatively, in the configuration of the CSI-RS, a CC-specific and/or UE-specific RRC parameter is defined as an energy value of the CSI-RS in the U-DRS.

As another embodiment, the configuration of the CRS can be used as a portion of the configuration of the U-DRS. In the configuration of the CSI-RS, a CC-specific and/or UE-specific RRC parameter (denoted as e.g., P_{C} or P_{D}) is defined as a ratio of an EPRE of LTE-U PDSCH to an EPRE of the CRS or a ratio of an EPRE of CSI-RS or CRS on the licensed carrier to an EPRE of the CRS. Further, if a low power U-DRS is adopted, the signal EPRE ratio has a value range of non-negative dB values. Alternatively, in the configuration of the CSI-RS, a CC-specific and/or UE-specific RRC parameter is defined as an energy value of the CRS in the U-DRS.

Scheme 2: a new IE, denoted as e.g., “U-SCellIndex”, is defined in LTE-U. The “U-SCellIndex” has an integer value and is used to indicate a short ID of an unlicensed carrier. Further, each “U-SCellIndex” is linked with a virtual “SCellIndex”. Here, “virtual” means that the “SCellIndex” is configured virtually for the unlicensed carrier indicated by “U-SCellIndex”, and the virtual “SCellIndex” may have been used by a licensed or unlicensed carrier. Preferably, the virtual “SCellIndex” has a value range of [N, 8], wherein N is an integer larger than 0 and smaller than 8.

Further, a detailed configuration of each unlicensed carrier includes at least a short ID of the unlicensed carrier “U-SCellIndex”, a virtually configured “SCellIndex” and frequency information (frequency point, bandwidth, etc.) of the unlicensed carrier. Further, in the configuration of the unlicensed carrier, its uplink configuration may need to be removed.

In addition, the U-DRSs on the unlicensed carriers can be configured, including the CC-specific and/or UE-specific power information as described above in connection with the step S105.

It is to be noted here that the maximum value of “U-SCellIndex” can be much larger than 7. Thus, compared with a licensed carrier, an LTE-U may have opportunities to use many unlicensed carriers.

It is also to be noted that, by linking each “U-SCellIndex” with a virtual “SCellIndex”, the LTE-U system can fully reuse the existing mechanism to determine on which resource the UE shall feed back acknowledgement information indicating whether the reception has succeeded.

It is also to be noted that, in practice, N can be generally a large number, e.g., N>4. This is the following purpose. According to the definition in the current LTE system, the larger the value of “SCellIndex”, the lower the operation priority of its corresponding carrier (e.g., in allocating resources for CSI feedback). The unlicensed carrier shall have a lower priority than the licensed carrier. In other words, in the LTE-U system, normal communication operations on the licensed carrier should be guaranteed with a high priority.

It is also be noted that, when receiving data, the UE generally does not need to consider a situation where downlink transmissions occur simultaneously on a licensed carrier having a short ID of “SCellIndex”=M and another unlicensed carrier having also a virtual “SCellIndex”=M.

As an embodiment, a new IE, denoted as e.g., “U-SCellIndex-r13”, can be defined in LTE-U. The value of the IE is a positive integer (1, 2, . . . , 10). For each unlicensed carrier, another IE, “U-SCellToAddMod-r13” can be defined to carry its detailed configuration. “U-SCellToAddMod-r13” includes at least a short ID of the unlicensed carrier, a virtually configured “SCellIndex” and frequency information (frequency point, bandwidth, etc.) of the unlicensed carrier. Further, in the configuration of the unlicensed carrier, its uplink configuration may need to be removed. Here, the short ID of the unlicensed carrier is carried by “U-SCellIndex-r13”, e.g., “U-SCellIndex-r13”=8. Another new IE (denoted as e.g., “virtualSCellIndex-r13”) is defined to carry the virtually configured “SCellIndex”. When determining “virtualSCellIndex-r13”, e.g., when N=4, the value range of “virtualSCellIndex-r13” is positive integers (5, 6, 7). The frequency information of the unlicensed carrier is similar to the frequency band indication corresponding to dl-CarrierFreq in TS 36.331. The exact frequency point information corresponding to the frequency band indication can be obtained from e.g., E-UTRA Operating Band in Table 5.7.3-1 of TS 36.101. It is to be noted here that all the tables here similar to Table 5.7.3-1 are tables of new frequency bands available at 5 GHz as predefined for LTE-U, as shown, but not limited to the situations defined, in Table 1 for example.

For configuration of the U-DRS, as an embodiment, a configuration of the CSI-RS can be used as a portion of the configuration of the U-DRS. In the configuration of the CSI-RS, a CC-specific and/or UE-specific RRC parameter (denoted as e.g., P_{C} or P_{D}) is defined as a ratio of an EPRE of LTE-U PDSCH to an EPRE of the CSI-RS or a ratio of an EPRE of CSI-RS or CRS on the licensed carrier to an EPRE of the CSI-RS. Further, if a low power U-DRS is adopted, the signal EPRE ratio has a value range of non-negative dB values. Alternatively, in the configuration of the CSI-RS, a CC-specific and/or UE-specific RRC parameter is defined as an energy value of the CSI-RS in the U-DRS.

As another embodiment, the configuration of the CRS can be used as a portion of the configuration of the U-DRS. In the configuration of the CSI-RS, a CC-specific and/or UE-specific RRC parameter (denoted as e.g., P_{C} or P_{D}) is defined as a ratio of an EPRE of LTE-U PDSCH to an EPRE of the CRS or a ratio of an EPRE of CSI-RS or CRS on the licensed carrier to an EPRE of the CRS. Further, if a low power U-DRS is adopted, the signal EPRE ratio has a value range of non-negative dB values. Alternatively, in the configuration of the CSI-RS, a CC-specific and/or UE-specific RRC parameter is defined as an energy value of the CRS in the U-DRS.

Scheme 3: a short ID of each licensed or unlicensed carrier is indicated by an existing Information Element (IE) “SCellIndex” (see TS 36.331) in RRC signaling of the current LTE system.

It differs from Scheme 1 in that a detailed configuration of each unlicensed carrier is basically similar to an existing IE “SCellToAddMod-r10” in RRC signaling of the current LTE system (see TS 36.331), with significant modifications (non-limiting) to: add a carrier type flag indicating whether a particular “SCellIndex” corresponds to a licensed carrier or an unlicensed carrier, and/or, when the carrier type flag indicates an unlicensed carrier, add list information carrying configurations for a set of candidate unlicensed carriers. The configurations for the set of candidate unlicensed carriers include at least a sub-index, denoted as e.g., “U-SCellSubIndex”, of a candidate unlicensed carrier and frequency information (frequency point, bandwidth, etc.) of the corresponding unlicensed carrier. Further, in the configuration of the unlicensed carrier, its uplink configuration may need to be removed. When the carrier type flag indicates a licensed carrier, the licensed carrier can be configured via an existing IE “SCellToAddMod-r10” in the LTE system.

In addition, the U-DRSs on the unlicensed carriers can be configured, including the CC-specific and/or UE-specific power information as described above in connection with the step S105.

It is to be noted here that there can be more than one “SCellIndex” for indicating unlicensed carriers. The present disclosure is not limited to any specific number of “SCellIndex”.

It is also to be noted that, there can be only one unlicensed carrier contained in the set of candidate unlicensed carriers. The present disclosure is not limited to any specific number of unlicensed carriers contained in the set.

It is to be noted here that the total number of candidate unlicensed carriers can be much larger than 7. Thus, compared with a licensed carrier, an LTE-U may have opportunities to use many unlicensed carriers.

It is also to be noted that, in practice, by linking each candidate unlicensed carrier with an “SCellIndex”, the LTE-U system can fully reuse the existing mechanism to determine on which resource the UE shall feed back acknowledgement information indicating whether the reception has succeeded.

It is also be noted that, when receiving data, the UE generally does not need to consider a situation where downlink transmissions occur simultaneously on a unlicensed carrier having a short ID of “SCellIndex”=M and another unlicensed carrier having also an “SCellIndex”=M.

As an embodiment, two “SCellIndex” (5, 7) are provided for indicating unlicensed carriers. For each “SCellIndex” (5 or 7), a modified IE “SCellToAddMod-r13” is defined to carry the detailed configuration of the unlicensed carrier. More particularly, “SCellToAddMod-r13” includes at least a carrier type flag (denoted as e.g., “SCellType-r13”, which is e.g., a Boolean value) indicating whether “SCellIndex” corresponds to a licensed carrier (e.g., when “SCellType-r13”=1) or an unlicensed carrier (e.g., when “SCellType-r13”=0). For the cases where “SCellIndex”=5 and “SCellIndex”=7, list information needs to be or can be configured for carrying a set of candidate unlicensed carriers, respectively. For example, for “SCellIndex”=5, a set of four candidate unlicensed carriers can be configured, which includes at least a sub-index (denoted as e.g., “U-SCellSubIndex-r13”), of a candidate unlicensed carrier and frequency information (frequency point, bandwidth, etc.) of the corresponding unlicensed carrier. Table 2 shows a relevant example. In Table 2, the frequency information of the candidate unlicensed carrier is similar to the frequency band indication corresponding to dl-CarrierFreq in TS 36.331. The exact frequency point information corresponding to the frequency band indication can be obtained from e.g., E-UTRA Operating Band in Table 5.7.3-1 of TS 36.101. It is to be noted here that all the tables here similar to Table 5.7.3-1 are tables of new frequency bands available at 5 GHz as predefined for LTE-U, as shown, but not limited to the situations defined, in Table 1 for example.

TABLE 2
Example of list containing four candidate unlicensed carriers

| U-SCellSubIndex-r13 | dl-CarrierFreq-r13 |
|---|---|
| 1 | 11 |
| 2 | 7 |
| 3 | 8 |
| 4 | 3 |

As another example, for “SCellIndex”=7, a set of seven candidate unlicensed carriers can be configured, which includes at least a sub-index (denoted as e.g., “U-SCellSubIndex-r13”), of a candidate unlicensed carrier and frequency information (frequency point, bandwidth, etc.) of the corresponding unlicensed carrier. Table 3 shows a relevant example. In Table 3, the frequency information of the candidate unlicensed carrier is similar to the frequency band indication corresponding to dl-CarrierFreq in TS 36.331. The exact frequency point information corresponding to the frequency band indication can be obtained from e.g., E-UTRA Operating Band in Table 5.7.3-1 of TS 36.101. It is to be noted here that all the tables here similar to Table 5.7.3-1 are tables of new frequency bands available at 5 GHz as predefined for LTE-U, as shown, but not limited to the situations defined, in Table 1 for example.

TABLE 3
Example of list containing seven candidate unlicensed carriers

| U-SCellSubIndex | dl-CarrierFreq-r13 |
|---|---|
| 1 | 2 |
| 2 | 16 |
| 3 | 5 |
| 4 | 13 |
| 5 | 14 |
| 6 | 1 |
| 7 | 9 |

For configuration of the U-DRS, as an embodiment, a configuration of the CSI-RS can be used as a portion of the configuration of the U-DRS. In the configuration of the CSI-RS, a CC-specific and/or UE-specific RRC parameter (denoted as e.g., P_{C} or P_{D}) is defined as a ratio of an EPRE of LTE-U PDSCH to an EPRE of the CSI-RS or a ratio of an EPRE of CSI-RS or CRS on the licensed carrier to an EPRE of the CSI-RS. Further, if a low power U-DRS is adopted, the signal EPRE ratio has a value range of non-negative dB values. Alternatively, in the configuration of the CSI-RS, a CC-specific and/or UE-specific RRC parameter is defined as an energy value of the CSI-RS in the U-DRS.

As another embodiment, the configuration of the CRS can be used as a portion of the configuration of the U-DRS. In the configuration of the CSI-RS, a CC-specific and/or UE-specific RRC parameter (denoted as e.g., P_{C} or P_{D}) is defined as a ratio of an EPRE of LTE-U PDSCH to an EPRE of the CRS or a ratio of an EPRE of CSI-RS or CRS on the licensed carrier to an EPRE of the CRS. Further, if a low power U-DRS is adopted, the signal EPRE ratio has a value range of non-negative dB values. Alternatively, in the configuration of the CSI-RS, a CC-specific and/or UE-specific RRC parameter is defined as an energy value of the CRS in the U-DRS.

At step S115, optionally, the UE performs measurement and feeds a measurement report back to the base station.

In this step, the UE measures the U-DRS on the unlicensed carrier configured in the step S110 and feeds a corresponding measurement report to the base station. It is to be noted that the measurement of the reference signal and the feedback of the measurement report are standard procedures in the current LTE network. The present disclosure is not limited to any specific implementation of this step.

At step S120, optionally, the base station configures the UE with unlicensed carriers for the UE to measure CSI and receive downlink transmission.

The set of unlicensed carriers for the UE to measure CSI and receive downlink transmission can be a subset of the unlicensed carriers for the UE to monitor the U-DRS as configured in the step S110. That is, the base station can select a portion of the unlicensed carriers configured in the step S110 as the set of unlicensed carriers for the UE to measure CSI and receive downlink transmission. Alternatively, the base station can use the set configured in the step S110 directly as the set of unlicensed carriers for the UE to measure CSI and receive downlink transmission.

When a portion of the unlicensed carriers configured in the step S110 are selected as the set of unlicensed carriers for the UE to measure CSI and receive downlink transmission, the set of unlicensed carriers for the UE to measure CSI and receive downlink transmission needs to be or can be configured via RRC signaling. The details of such RRC signaling configuration are the same as those described in connection with the step S110, except that the number of unlicensed carriers is reduced. Further details will be omitted here.

When the set configured in the step S110 is used directly as the set of unlicensed carriers for the UE to measure CSI and receive downlink transmission, it is only required to define the set of unlicensed carriers for the UE to measure CSI and receive downlink transmission to be the same as the set of unlicensed carriers for the UE to monitor the U-DRS in advance, without any further operations.

When it is agreed in advance which carriers in the set of unlicensed carriers to monitor the U-DRS, as configured by the base station, are to be used by the UE for measuring CSI and receiving downlink transmission, this configuration step can be omitted.

For the unlicensed carriers for the UE to measure CSI and receive downlink transmission in this step, it is required to configured how to perform cross carrier scheduling, e.g., whether cross carrier scheduling is required, on which carrier the UE shall receive cross carrier scheduling, etc. This configuration can be implemented using an existing IE “CrossCarrierSchedulingConfig” in RRC signaling of the current LTE system. In this IE, the downlink scheduling information of an unlicensed carrier will be configured to be always received on a licensed carrier.

It is to be noted that all the three schemes described in connection with the step S110 are applicable to the step S120.

At step S125, optionally, the UE measures CSI on the configured unlicensed carrier and feeds the CSI back.

In this step, the UE can receive a reference signal for measuring CSI transmitted from the base station on the unlicensed carrier configured on the unlicensed carrier in the step S120, measure CSI and feed the CSI back to the base station. It is to be noted that the measurement and feedback of CSI are standard procedures in the current LTE network. The present disclosure is not limited to any specific implementation of this step.

At step S130, optionally, the base station decides when and how to use the unlicensed carrier.

In order to allow the LTE system to share resources of unlicensed carriers with other systems (e.g., Wi-Fi system) fairly, the base station needs to decide when and how to use the unlicensed carriers. This is a step performed inside the base station and the present disclosure is not limited to any specific implementation of this step.

At step S135, optionally, the base station transmits cross carrier scheduling information to the UE on a licensed carrier and transmits downlink data on an unlicensed carrier.

For this purpose, the present disclosure provides three schemes based on Downlink Control Information (DCI). These three schemes are based on the three schemes described in connection with the steps S110 and S120, respectively.

Scheme 1: Based on Scheme 1 in the steps S110 and S120, DCI signaling of the current LTE system can be used directly for cross carrier scheduling downlink transmission on unlicensed carriers in the LTE-U system. More particularly, in the downlink cross carrier scheduling DCI in the current LTE system, each of DCI formats 1, 1A, 1 B, 1 D, 2, 2A, 2B and 2C contains a 3-bit field for indicating an “SCellIndex” corresponding to a target carrier to be scheduled by the DCI. The 3-bit field can be referred to as a Carrier Indicator Field (CIF).

It is to be noted here that the carrier corresponding to “SCellIndex” can be a licensed carrier or an unlicensed carrier. This is because, in Scheme 1, the values of “SCellIndex” need to be shared among licensed and unlicensed carriers.

As an embodiment, it is assumed that “SCellIndex”=0 corresponds to a licensed carrier (the carrier corresponding to “SCellIndex”=0 is also referred to as primary carrier in the LTE system) and “SCellIndex”=6 corresponds to an unlicensed carrier. It is further assumed that, in the step S120, the carrier corresponding to “SCellIndex”=6 is configured to receive cross carrier scheduling information on the carrier corresponding to “SCellIndex”=0. Then, in the DCI of carrier corresponding to “SCellIndex”=0 for cross carrier scheduling the carrier corresponding to “SCellIndex”=6, the CIF should be set to 110 (indicating that the carrier corresponding to “SCellIndex”=6 is being scheduled). The other information in the DCI complies with the definition in the LTE system.

As another embodiment, it is assumed that “SCellIndex”=2 corresponds to a licensed carrier (the carrier corresponding to “SCellIndex”=2 is also referred to as secondary carrier in the LTE system) and “SCellIndex”=6 corresponds to an unlicensed carrier. It is further assumed that, in the step S120, the carrier corresponding to “SCellIndex”=6 is configured to receive cross carrier scheduling information on the carrier corresponding to “SCellIndex”=2. Then, in the DCI of carrier corresponding to “SCellIndex”=2 for cross carrier scheduling the carrier corresponding to “SCellIndex”=6, the CIF should be set to 110 (indicating that the carrier corresponding to “SCellIndex”=6 is being scheduled). The other information in the DCI complies with the definition in the LTE system.

This scheme is advantageous in that no new bits are needed when compared with the existing DCI formats, such that the cross carrier scheduling of an unlicensed carrier can be achieved without additional overhead.

Scheme 2: Based on Scheme 2 in the steps S110 and S120, the base station uses a reserved state of CIF, i.e., 000 (or any other particular value), to indicate that the current downlink scheduling is for an unlicensed carrier, and uses a number of bits in another field or a number of newly defined bits in the DCI for carrying “U-SCellIndex” information, thereby indicating which unlicensed carrier the current downlink scheduling is intended for. Preferably, the number of bits in the other filed in the DCI includes “HARQ process number” (for downlink retransmission originally) and/or “Downlink Assignment Index” (for TDD system originally) in the DCI.

It is to be noted here that the fields “HARQ process number” and “Downlink Assignment Index” (for TDD system only) in the DCI are both present in the downlink cross carrier scheduling DCI (DCI formats 1, 1A, 1B, 1C, 1D, 2, 2A, 2B and 2C).

As an embodiment, it is assumed that “SCellIndex”=0 corresponds to a licensed carrier (the carrier corresponding to “SCellIndex”=0 is also referred to as primary carrier in the LTE system) and “U-SCellIndex”=3 corresponds to an unlicensed carrier. It is further assumed that, in the step S120, the carrier corresponding to “U-SCellIndex”=3 is configured to receive cross carrier scheduling information on the carrier corresponding to “SCellIndex”=0. Then, in the DCI of carrier corresponding to “SCellIndex”=0 for cross carrier scheduling the carrier corresponding to “U-SCellIndex”=3, the CIF should be set to 000 (a reserved state). Additionally, two bits in the field “HARQ process number” in the DCI are set to 11, indicating that the unlicensed carrier corresponding to “U-SCellIndex”=3 is being scheduled. The other information in the DCI complies with the definition in the LTE system.

As another embodiment, it is assumed that “SCellIndex”=0 corresponds to a licensed carrier (the carrier corresponding to “SCellIndex”=0 is also referred to as primary carrier in the LTE system) and “U-SCellIndex”=5 corresponds to an unlicensed carrier. It is further assumed that, in the step S120, the carrier corresponding to “U-SCellIndex”=5 is configured to receive cross carrier scheduling information on the carrier corresponding to “SCellIndex”=0. Then, in the DCI of carrier corresponding to “SCellIndex”=0 for cross carrier scheduling the carrier corresponding to “U-SCellIndex”=5, the CIF should be set to 000 (a reserved state). Additionally, three new bits are defined in the DCI and set to 101, indicating that the unlicensed carrier corresponding to “U-SCellIndex”=5 is being scheduled. The other information in the DCI complies with the definition in the LTE system.

As another embodiment, it is assumed that “SCellIndex”=2 corresponds to a licensed carrier (the carrier corresponding to “SCellIndex”=2 is also referred to as secondary carrier in the LTE system) and “U-SCellIndex”=3 corresponds to an unlicensed carrier. It is further assumed that, in the step S120, the carrier corresponding to “U-SCellIndex”=3 is configured to receive cross carrier scheduling information on the carrier corresponding to “SCellIndex”=0. Then, in the DCI of carrier corresponding to “SCellIndex”=0 for cross carrier scheduling the carrier corresponding to “U-SCellIndex”=3, the CIF should be set to 000 (a reserved state). Additionally, two bits in the field “HARQ process number” in the DCI are set to 11, indicating that the unlicensed carrier corresponding to “U-SCellIndex”=3 is being scheduled. The other information in the DCI complies with the definition in the LTE system.

As another embodiment, it is assumed that “SCellIndex”=2 corresponds to a licensed carrier (the carrier corresponding to “SCellIndex”=2 is also referred to as secondary carrier in the LTE system) and “U-SCellIndex”=5 corresponds to an unlicensed carrier. It is further assumed that, in the step S120, the carrier corresponding to “U-SCellIndex”=5 is configured to receive cross carrier scheduling information on the carrier corresponding to “SCellIndex”=0. Then, in the DCI of carrier corresponding to “SCellIndex”=0 for cross carrier scheduling the carrier corresponding to “U-SCellIndex”=5, the CIF should be set to 000 (a reserved state). Additionally, three new bits are defined in the DCI and set to 101, indicating that the unlicensed carrier corresponding to “U-SCellIndex”=5 is being scheduled. The other information in the DCI complies with the definition in the LTE system.

This scheme is advantageous in that the cross carrier scheduling of an unlicensed carrier can be achieved in a more efficient manner and the implementation complexity of the system can be reduced. Meanwhile, the above preferred scheme does not introduce additional system overhead.

Scheme 3: Based on Scheme 3 in the steps S110 and S120, when some “SCellIndex” have been defined as representing unlicensed carriers, the base station can set a CIF as such “SCellIndex” to indicate the current downlink scheduling is for an unlicensed carrier. Further, the base station uses a number of bits in another field or a number of newly defined bits in the DCI for carrying “U-SCellSubIndex” information, thereby indicating which unlicensed carrier among the unlicensed carriers represented by the “SCellIndex” the current downlink scheduling is intended for. Preferably, the number of bits in the other filed in the DCI includes “HARQ process number” (for downlink retransmission originally) and/or “Downlink Assignment Index” (for TDD system originally) in the DCI.

It is to be noted here that the fields “HARQ process number” and “Downlink Assignment Index” (for TDD system only) in the DCI are both present in the downlink cross carrier scheduling DCI (DCI formats 1, 1A, 1B, 1C, 1D, 2, 2A, 2B and 2C).

As an embodiment, it is assumed that “SCellIndex”=0 corresponds to a licensed carrier (the carrier corresponding to “SCellIndex”=0 is also referred to as primary carrier in the LTE system) and another “SCellIndex”=5 corresponds to a set of four candidate unlicensed carriers (see Table 2). It is further assumed that, in the step S120, the carrier corresponding to “SCellIndex”=5 is configured to receive cross carrier scheduling information on the carrier corresponding to “SCellIndex”=0. Further, the unlicensed carrier corresponding to “U-SCellSubIndex=2” in Table 2 is selected by the base station as the carrier for downlink transmission. Then, in the DCI of carrier corresponding to “SCellIndex”=0 for cross carrier scheduling the carrier corresponding to “SCellIndex”=5, the CIF should be set to 101 (indicating that the carrier corresponding to “SCellIndex”=5 is being scheduled). Additionally, two bits in the field “HARQ process number” in the DCI are set to 10, indicating that the unlicensed carrier corresponding to “U-SCellSubIndex=2” is being scheduled. The other information in the DCI complies with the definition in the LTE system.

As another embodiment, it is assumed that “SCellIndex”=0 corresponds to a licensed carrier (the carrier corresponding to “SCellIndex”=0 is also referred to as primary carrier in the LTE system) and another “SCellIndex”=5 corresponds to a set of seven candidate unlicensed carriers (see Table 3). It is further assumed that, in the step S120, the carrier corresponding to “SCellIndex”=5 is configured to receive cross carrier scheduling information on the carrier corresponding to “SCellIndex”=0. Further, the unlicensed carrier corresponding to “U-SCellSubIndex=6” in Table 2 is selected by the base station as the carrier for downlink transmission. Then, in the DCI of carrier corresponding to “SCellIndex”=0 for cross carrier scheduling the carrier corresponding to “SCellIndex”=5, the CIF should be set to 101 (indicating that the carrier corresponding to “SCellIndex”=5 is being scheduled). Additionally, three new bits are defined in the DCI and set to 110, indicating that the unlicensed carrier corresponding to “U-SCellSubIndex=6” is being scheduled. The other information in the DCI complies with the definition in the LTE system.

As another embodiment, it is assumed that “SCellIndex”=2 corresponds to a licensed carrier (the carrier corresponding to “SCellIndex”=2 is also referred to as secondary carrier in the LTE system) and another “SCellIndex”=5 corresponds to a set of four candidate unlicensed carriers (see Table 2). It is further assumed that, in the step S120, the carrier corresponding to “SCellIndex”=5 is configured to receive cross carrier scheduling information on the carrier corresponding to “SCellIndex”=2. Further, the unlicensed carrier corresponding to “U-SCellSubIndex=2” in Table 2 is selected by the base station as the carrier for downlink transmission. Then, in the DCI of carrier corresponding to “SCellIndex”=2 for cross carrier scheduling the carrier corresponding to “SCellIndex”=5, the CIF should be set to 101 (indicating that the carrier corresponding to “SCellIndex”=5 is being scheduled). Additionally, two bits in the field “HARQ process number” in the DCI are set to 10, indicating that the unlicensed carrier corresponding to “U-SCellSubIndex=2” is being scheduled. The other information in the DCI complies with the definition in the LTE system.

As another embodiment, it is assumed that “SCellIndex”=2 corresponds to a licensed carrier (the carrier corresponding to “SCellIndex”=2 is also referred to as secondary carrier in the LTE system) and another “SCellIndex”=5 corresponds to a set of seven candidate unlicensed carriers (see Table 3). It is further assumed that, in the step S120, the carrier corresponding to “SCellIndex”=5 is configured to receive cross carrier scheduling information on the carrier corresponding to “SCellIndex”=2. Further, the unlicensed carrier corresponding to “U-SCellSubIndex=6” in Table 2 is selected by the base station as the carrier for downlink transmission. Then, in the DCI of carrier corresponding to “SCellIndex”=2 for cross carrier scheduling the carrier corresponding to “SCellIndex”=5, the CIF should be set to 101 (indicating that the carrier corresponding to “SCellIndex”=5 is being scheduled). Additionally, three new bits are defined in the DCI and set to 110, indicating that the unlicensed carrier corresponding to “U-SCellSubIndex=6” is being scheduled. The other information in the DCI complies with the definition in the LTE system.

This scheme is advantageous in that it allows cross carrier scheduling an unlicensed carrier freely in a wider range.

Moreover, with the above preferred scheme, no additional bits are defined. Instead, a number of bits in another field in the DCI (“HARQ process number” (for downlink retransmission originally) and/or “Downlink Assignment Index” (for TDD system originally)) are used for carrying the “U-SCellSubIndex” information. In this case, while achieving the above advantages, the system overhead will not increase.

At step S140, optionally, the UE receives the cross carrier scheduling information on the licensed carrier and receives downlink data on the unlicensed carrier.

In this step, the UE receives the cross carrier scheduling information on the licensed carrier and receives downlink data on the unlicensed carrier.

Preferably, in order to save system overhead, a Physical Downlink Control Channel (PDCCH) region on the unlicensed carrier can be reduced to zero. For achieving this technique, when configuring the cross carrier scheduling information in the step S120, the downlink control channel on the unlicensed carrier can be configured to zero. Alternatively, the downlink control channel on the unlicensed carrier can be predefined as zero, without any additional signaling overhead.

As an embodiment, when configuring the cross carrier scheduling information of the unlicensed carrier in the step S120, a field “pdsch-Start” in the IE “CrossCarrierSchedulingConfig” can be set to zero.

As an embodiment, the start OFDM symbol position of PDSCH of the unlicensed carrier can be predefined as zero, without any configuration via signaling.

As such, a PDCCH region on the unlicensed carrier can be reduced to zero. In this way, the system overhead can be saved and the spectrum utilization can be improved.

At step S145, optionally, the UE feeds back acknowledgement information indicating whether the reception has succeeded.

In this step, if the downlink reception has succeeded, the UE generates ACK information; otherwise, the UE generates NAK information. Then, the UE feeds the ACK/NAK information back to the base station. It is to be noted that the ACK/NAK feedback is a standard procedure in the current LTE network. The present disclosure is not limited to any specific implementation of this step.

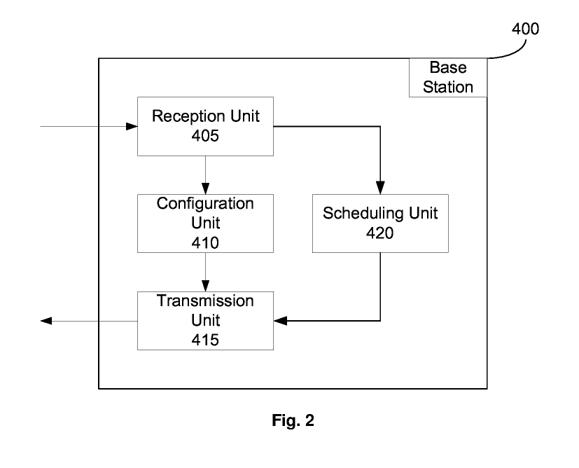

FIG. 2 is a block diagram showing a structure of a base station 400 according to an embodiment of the present disclosure. As shown in FIG. 2, the base station 400 includes at least a transmission unit 415 configured to transmit an Unlicensed-Discovery Reference Signal (U-DRS) on an unlicensed carrier. The base station 400 can further include a reception unit 405, a configuration unit 410 and a scheduling unit 420. The reception unit 405 can receive a monitor report on the unlicensed carrier, a CSI report and acknowledgement information indicating whether the downlink data has been successfully transmitted, as transmitted from the UE. The configuration unit 410 can configure unlicensed carriers for the UE to monitor the U-DRS and unlicensed carriers for the UE to measure CSI and receive downlink transmission. The transmission unit 415 can further be configured to transmit an unlicensed carrier configuration on a licensed carrier for the UE to monitor the U-DRS, transmit an unlicensed carrier configuration on a licensed carrier for the UE to measure CSI and receive downlink transmission, transmit cross carrier scheduling information on a licensed carrier, and transmit downlink data on the unlicensed carrier. The scheduling unit 420 can decide when and how to use the unlicensed carrier, and to generate cross carrier scheduling information.

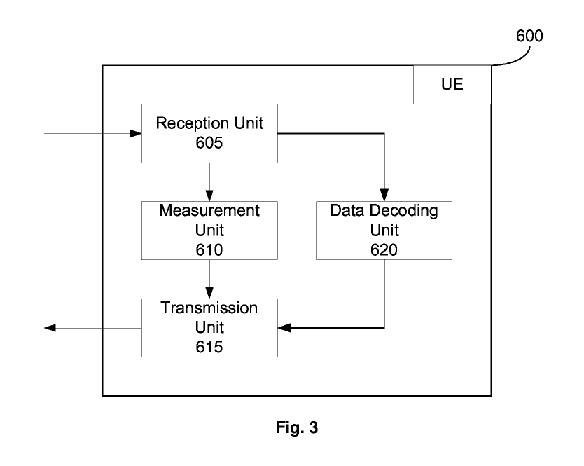

FIG. 3 is a block diagram showing a structure of a UE according to an embodiment of the present disclosure. As shown in FIG. 3, the UE 600 includes at least a reception unit 605 configured to receive an Unlicensed-Discovery Reference Signal (U-DRS) on an unlicensed carrier. The UE 600 can further include a measurement unit 610, a transmission unit 615 and a data decoding unit 620. The reception unit 605 can further be configured to receive a configuration of unlicensed carriers for monitoring the (low power) U-DRS on a licensed carrier, receive a configuration of unlicensed carriers for measuring CSI and receiving downlink transmission on a licensed carrier, receive a reference signal for measuring Channel State Information (CSI) on the unlicensed carrier, receive cross carrier scheduling information on a licensed carrier, and receive downlink data on the unlicensed carrier. The measurement unit 610 can measure the (low power) U-DRS and generate a measurement report, and to measure CSI of the unlicensed carrier and generate a CSI report. The transmission unit 615 can transmit the measurement report based on the (low power) U-DRS, the CSI report of the unlicensed carrier, and acknowledgement information indicating whether the downlink data has been successfully received. The data decoding unit 620 can decode the cross carrier scheduling information and the downlink data, and generate acknowledgement information indicating whether the downlink data has been successfully received.

It can be appreciated that the above embodiments of the present disclosure can be implemented in software, hardware or any combination thereof. For example, the internal components of the base station and the UE in the above embodiments can be implemented using various devices including, but not limited to, analog circuit device, digital circuit device, Digital Signal Processing (DSP) circuit, programmable processor, Application Specific Integrated Circuit (ASIC), Field Programmable Gate Array (FPGA), Programmable Logic Device (CPLD) and the like.

In the present disclosure, the term “base station” refers in general to a wireless communication transmission node, e.g., a macro base station, a micro base station, a relay, or the like, which includes at least functions of transmitting and receiving data. The term “user equipment” refers to a user mobile terminal, including e.g., a mobile phone, a notebook computer and other terminal devices that can wirelessly communicate with a base station or and micro base station.

Further, the embodiments of the present disclosure can be implemented in computer program products. More specifically, a computer program product can be a product having a computer readable medium with computer program logics coded thereon. When executed on a computing device, the computer program logics provide operations for implementing the above solutions according to the present disclosure. When executed on at least one processor in a computing system, the computer program logics cause the processor to perform the operations (methods) according to the embodiments of the present disclosure. This arrangement of the present disclosure is typically provided as software, codes and/or other data structures provided or coded on a computer readable medium (such as an optical medium, e.g., CD-ROM, a floppy disk or a hard disk), or firmware or micro codes on other mediums (such as one or more ROMs, RAMs or PROM chips), or downloadable software images or shared databases in one or more modules. The software, firmware or arrangement can be installed in a computing device to cause one or more processors in the computing device to perform the solutions according to the embodiments of the present disclosure.

The present disclosure has been described above with reference to the preferred embodiments thereof. It should be understood that various modifications, alternations and additions can be made by those skilled in the art without departing from the spirits and scope of the present disclosure. Therefore, the scope of the present disclosure is not limited to the above particular embodiments but only defined by the claims as attached and the equivalents thereof.

1. A method performed by a base station for enabling communication on an unlicensed spectrum, comprising:
transmitting, by the base station, an Unlicensed-Discovery Reference Signal (U-DRS) on an unlicensed carrier.

2. The method of claim 1, further comprising:
transmitting, by the base station, a reference signal for measuring Channel State Information (CSI) on the unlicensed carrier.

3. (canceled)

4. The method of claim 1, further comprising:
configuring, by the base station, a UE with unlicensed carriers for the UE to monitor the U-DRS.

5-28. (canceled)

29. A base station, comprising:
a transmission unit configured to transmit an Unlicensed-Discovery Reference Signal (U-DRS) on an unlicensed carrier.

30. The base station of claim 29, wherein the transmission unit is further configured to transmit a reference signal for measuring Channel State Information (CSI) on the unlicensed carrier.

31. The base station of claim 29, wherein the transmission unit is further configured to transmit downlink data to a User Equipment (UE) on the unlicensed carrier.

32. The base station of claim 29, further comprising:
a configuration unit configured to generate a first unlicensed carrier configuration for configuring unlicensed carriers for the UE to monitor the U-DRS,
wherein the transmission unit is configured to transmit the first unlicensed carrier configuration on a licensed carrier.

33. The base station of claim 30, further comprising:
a configuration unit configured to generate a second unlicensed carrier configuration for configuring unlicensed carriers for the UE to measure CSI and receive downlink data,
wherein the transmission unit is configured to transmit the second unlicensed carrier configuration on a licensed carrier.

34. The base station of claim 32 or 33, wherein
a subset of the unlicensed carriers for the UE to monitor the U-DRS is selected as the unlicensed carriers for the UE to measure CSI and receive downlink data, or
all of the unlicensed carriers for the UE to monitor the U-DRS are selected as the unlicensed carriers for the UE to measure CSI and receive downlink data.

35. The base station of claim 31, further comprising:
a scheduling unit configured to generate cross carrier scheduling information,
wherein the transmission unit is further configured to transmit cross carrier scheduling information on a licensed carrier, and
wherein the downlink data is transmitted on an unlicensed carrier indicated by the cross carrier scheduling information.

36. The base station of claim 31, further comprising:
a reception unit configured to receive a monitor report on the unlicensed carrier, a CSI report and acknowledgement information indicating whether the downlink data has been successfully transmitted, as fed back from the UE.

37. A User Equipment (UE), comprising:
a reception unit configured to receive an Unlicensed-Discovery Reference Signal (U-DRS) on an unlicensed carrier.

38. The UE of claim 37, wherein the reception unit is further configured to receive a reference signal for measuring Channel State Information (CSI) on the unlicensed carrier.

39. The UE of claim 37 or 38, wherein the reception unit is further configured to receive downlink data on the unlicensed carrier.

40. The UE of claim 37, wherein the reception unit is further configured to receive a configuration of unlicensed carriers for monitoring the U-DRS on a licensed carrier.

41. The UE of claim 38, wherein the reception unit is further configured to receive a configuration of unlicensed carriers for measuring CSI and receiving downlink data from the base station on a licensed carrier.

42. The UE of claim 40 or 41, wherein
a subset of the unlicensed carriers for monitoring the U-DRS is selected as the unlicensed carriers for measuring CSI and receiving downlink data, or
all of the unlicensed carriers for monitoring the U-DRS are selected as the unlicensed carriers for measuring CSI and receiving downlink data.

43. The UE of claim 38, further comprising:
a measurement unit configured to measure the U-DRS and generate a measurement report, and to measure CSI and generate a CSI report; and
a transmission unit configured to transmit the measurement report based on the U-DRS and the CSI report.

44. The UE of claim 39, wherein the reception unit is further configured to receive cross carrier scheduling information on a licensed carrier, the UE further comprises:
a data decoding unit configured to decode the cross carrier scheduling information, and
the downlink data is received on an unlicensed carrier indicated by the cross carrier scheduling information.

45. The UE of claim 44, wherein
the data decoding unit is further configured to decode the downlink data and generate acknowledgement information indicating whether the downlink data has been successfully received, and
the transmission unit is further configured to feed the acknowledgement information back to a base station.
